(19) United States
(12) Patent Application Publication
(10) Pub. No.: US 2023/0410255 A1
(43) Pub. Date: Dec. 21, 2023

(54) DECREASED QUANTIZATION LATENCY

(71) Applicant: QUALCOMM Incorporated, San Diego, CA (US)

(72) Inventors: Wenhao ZHANG, Beijing (CN); Zhiguo LI, Beijing (CN); Ronghui LIN, Shenzhen (CN); Zhiping PANG, Shanghai (CN)

(21) Appl. No.: 18/251,220

(22) PCT Filed: Jan. 22, 2021
(86) PCT No.: PCT/CN2021/073299

§ 371 Date: Apr. 28, 2023

(51) Int. Cl. G06T 3/40; G06F 9/50

(52) U.S. Cl. CPC G06T 3/4046; G06F 9/5027

(57) ABSTRACT

Systems and techniques are described herein for decreasing quantization latency. In some aspects, a process includes determining a first integer data type of data at least one layer of a neural network is configured to process, and determining a second integer data type of data received for processing by the neural network. The second integer data type can be different than the first integer data type. The process further includes determining a ratio between a first size of the first integer data type and a second size of the second integer data type, and scaling parameters of the at least one layer of the neural network using a scaling factor corresponding to the ratio. The process further includes quantize the scaled parameters of the neural network, and inputting the received data to the neural network with the quantized and scaled parameters.

### TECHNICAL FIELD

The present disclosure is related to decreasing quantization latencies for data processed by neural networks. Some aspects of the present disclosure relate to incorporating quantization processes into neural networks implemented by hardware accelerators.

### BACKGROUND

Many devices and systems allow a scene to be captured by generating images (or frames) and/or video data (including multiple frames) of the scene. For example, a camera or a computing device including a camera (e.g., a mobile device such as a mobile telephone or smartphone including one or more cameras) can capture a sequence of frames of a scene. The image and/or video data can be captured and processed by such devices and systems (e.g., mobile devices, IP cameras, etc.) and can be output for consumption (e.g., displayed on the device and/or other device). In some cases, the image and/or video data can be captured by such devices and systems and output for processing and/or consumption by other devices.

Machine learning models (such as neural networks) can be used to perform high-quality image processing operations (among other operations). In some cases, hardware accelerators (e.g., digital signal processors (DSPs), neural processing units (NPUs), etc.) can be used to reduce the time and/or computing power involved in implementing machine learning models. Hardware accelerators can be configured to perform calculations using digital data having a particular data format (e.g., a particular integer data type). Data that is to be processed by a machine learning model implemented by a hardware accelerator must be converted (e.g., normalized and/or quantized) to have a corresponding data format.

### SUMMARY OF THE INVENTION

Systems and techniques are described herein for decreasing quantization latencies for data processed by neural networks. According to one illustrative example, a method for decreasing quantization latency is provided that includes: determining a first integer data type of data at least one layer of a neural network is configured to process; determining a second integer data type of data received for processing by the neural network, the second integer data type being different than the first integer data type; determining a ratio between a first size of the first integer data type and a second size of the second integer data type; scaling parameters of the at least one layer of the neural network using a scaling factor corresponding to the ratio; quantizing the scaled parameters of the neural network; and inputting the received data to the neural network with the quantized and scaled parameters.

In another example, an apparatus for decreasing quantization latency is provided that includes a memory and one or more processors (e.g., implemented in circuitry) coupled to the memory. The one or more processors are configured to and can: determine a first integer data type of data at least one layer of a neural network is configured to process; determine a second integer data type of data received for processing by the neural network, the second integer data type being different than the first integer data type; determine a ratio between a first size of the first integer data type and a second size of the second integer data type; scale parameters of the at least one layer of the neural network using a scaling factor corresponding to the ratio; quantize the scaled parameters of the neural network; and input the received data to the neural network with the quantized and scaled parameters.

In another example, a non-transitory computer-readable medium is provided that has stored thereon instructions that, when executed by one or more processors, cause the one or more processor to: determine a first integer data type of data at least one layer of a neural network is configured to process; determine a second integer data type of data received for processing by the neural network, the second integer data type being different than the first integer data type; determine a ratio between a first size of the first integer data type and a second size of the second integer data type; scale parameters of the at least one layer of the neural network using a scaling factor corresponding to the ratio; quantize the scaled parameters of the neural network; and input the received data to the neural network with the quantized and scaled parameters.

In another example, an apparatus for determining exposure for one or more frames is provided. The apparatus includes: means for determining a first integer data type of data at least one layer of a neural network is configured to process; means for determining a second integer data type of data received for processing by the neural network, the second integer data type being different than the first integer data type; means for determining a ratio between a first size of the first integer data type and a second size of the second integer data type; means for scaling parameters of the at least one layer of the neural network using a scaling factor corresponding to the ratio; means for quantizing the scaled parameters of the neural network; and means for inputting the received data to the neural network with the quantized and scaled parameters.

In some aspects, the method, apparatuses, and computer-readable medium described above further comprise implementing the neural network using a hardware accelerator and data of the first integer data type.

In some aspects, the received data includes image data captured by a camera device. In some aspects, the neural network is trained to perform one or more image processing operations on the image data.

In some aspects, the method, apparatuses, and computer-readable medium described above further comprise training the neural network using training data of a floating point data type. In some cases, training the neural network generates neural network parameters of the floating point data type.

In some aspects, the method, apparatuses, and computer-readable medium described above further comprise converting the neural network parameters from the floating point data type to the first integer data type.

In some aspects, the at least one layer of the neural network corresponds to a single layer of the neural network. In some aspects, the scaling factor is the ratio between the first size of the first integer data type and the second size of the second integer data type.

In some aspects, the first size of the first integer data type corresponds to a first number of distinct integers the first integer data type is configured to represent. In some aspects, the second size of the second integer data type corresponds to a second number of distinct integers the second integer data type is configured to represent.

In some aspects, the at least one layer of the neural network includes a convolutional layer or a deconvolution layer. In some aspects, the at least one layer of the neural network includes a scale layer. In some aspects, the at least one layer of the neural network includes a layer that performs an elementwise operation.

In some aspects, the method, apparatuses, and computer-readable medium described above further comprise inputting the received data to the neural network without quantizing the received data.

In some aspects, the method, apparatuses, and computer-readable medium described above further comprise quantizing parameters of one or more additional layers of the neural network.

In some aspects, one or more of the apparatuses described above is, is part of, and/or includes a mobile device (e.g., a mobile telephone or so-called “smart phone” or other mobile device), a camera, an extended reality device (e.g., a virtual reality (VR) device, an augmented reality (AR) device, or a mixed reality (MR) device), a wearable device (e.g., a network-connected watch or other wearable device), a personal computer, a laptop computer, a server computer, a vehicle or a computing device or component of a vehicle, or other device. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyrometers, one or more accelerometers, any combination thereof, and/or other sensor).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an example architecture of an image capture and processing system, in accordance with some examples;

FIG. 2A is a block diagram illustrating an example system for training a neural network using floating point data, in accordance with some examples;

FIG. 2B is a block diagram illustrating an example system for quantizing neural networks in accordance with some examples;

FIG. 3 is a block diagram illustrating another example system for quantizing neural networks, in accordance with some examples;

FIG. 4 is a flow diagram illustrating an example of a process for decreasing quantization latency, in accordance with some examples;

FIG. 5 is a diagram illustrating an example of a visual model for a neural network in accordance with some examples;

FIG. 6A is a diagram illustrating an example of a model for a neural network that includes feed-forward weights and recurrent weights, in accordance with some examples;

FIG. 6B is a diagram illustrating an example of a model for a neural network that includes different connection types, in accordance with some examples;

FIG. 7 is a diagram illustrating an example of a model for a convolutional neural network, in accordance with some examples;

FIG. 8 is a diagram illustrating an example of a system for implementing certain aspects described herein.

### DETAILED DESCRIPTION OF THE EMBODIMENTS

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Machine learning models (such as neural networks) can perform various image processing operations, natural language processing operations, and other operations. In some cases, hardware accelerators (e.g., digital signal processors (DSPs), neural processing units (NPUs), etc.) can be used to reduce the time and/or computing power involved in implementing machine learning models. A hardware accelerator may be configured to perform calculations using digital data of a particular integer data type (e.g., INT12, INT16, etc.). In some cases, raw data that is to be processed by the hardware accelerator may not have a corresponding data type. For instance, a camera system may generate image frames with INT10 image data, while a hardware accelerator may be configured to process INT16 data. The raw input data must be converted to an appropriate data format before being processed by the hardware accelerator, which can traditionally involve high-latency normalization and/or quantization pre-processes.

The present disclosure describes systems, apparatuses, methods, and computer-readable media (collectively referred to as “systems and techniques”) for decreasing latencies in quantization pre-processes. The systems and techniques can provide the ability for a neural network to effectively quantize input data within one or more layers of the neural network. For example, data of one integer data type can be converted to another integer data type by scaling the data based on a ratio between the sizes (e.g., integer value ranges) of the integer data types. The disclosed systems and techniques can incorporate any necessary quantization pre-processes into the neural network by appropriately scaling the parameters of one neural network layer (e.g., multiplying the parameter values by the ratio). In this way, input data can be passed directly to the neural network during inference, and quantization pre-processes can be eliminated or greatly reduced.

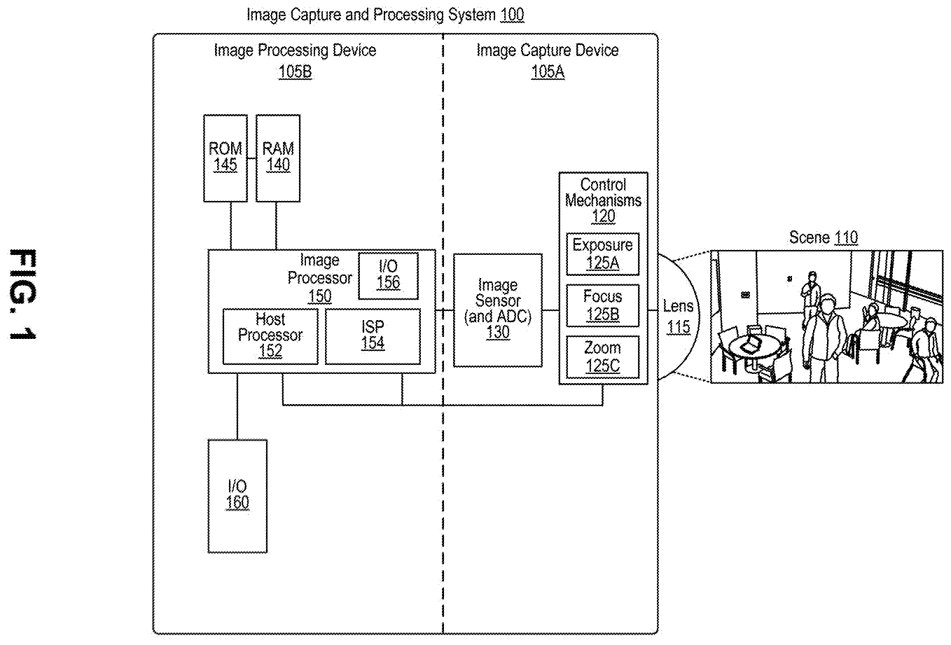

Further details regarding decreasing quantization latency are provided herein with respect to various figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 810. In an illustrative example, the image processor 150 can represent and/or include a hardware accelerator (e.g., an NPU) configured to implement neural networks. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as quantizing input data (e.g., raw image data captured by the image sensor 130), de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1220, read-only memory (ROM) 145/1225, a cache 1212, a memory unit 1215, another storage device 1230, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1235, any other input devices 1245, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

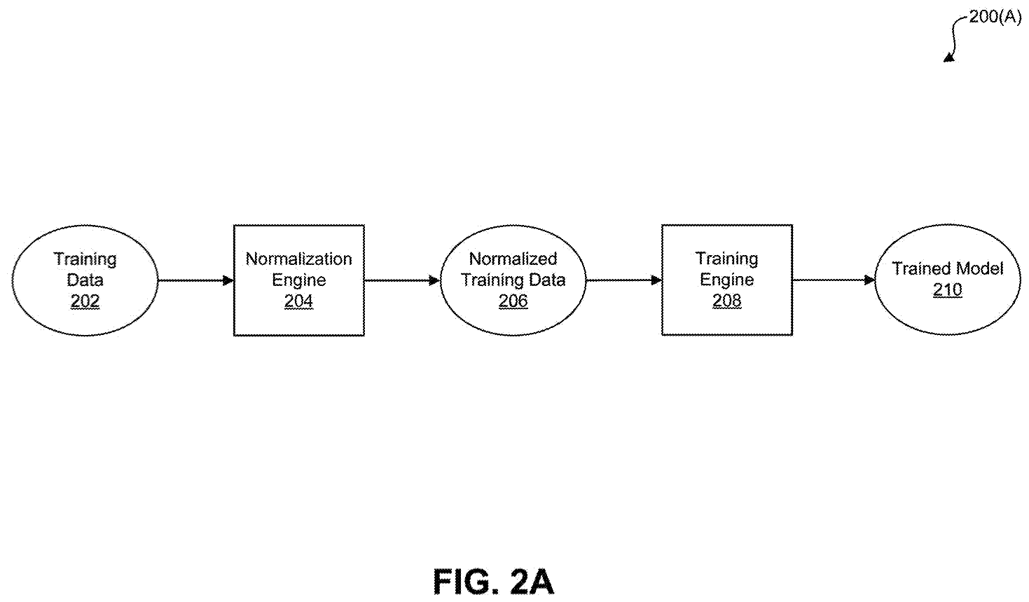

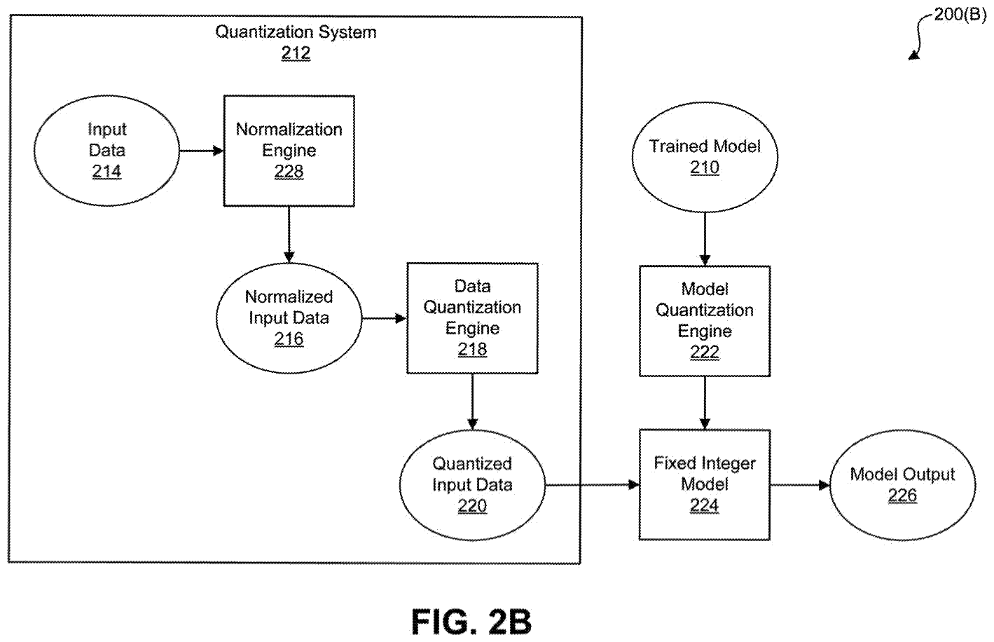

FIG. 2A is a block diagram illustrating an example of a model-training system 200(A). In some examples, the model-training system 200(A) can be implemented by the image capture and processing system 100 illustrated in FIG. 1. For example, the model-training system 200(A) can be implemented by the image processor 150, the image sensor 130, and/or any additional component of the image capture and processing system 100. In other examples, the model-training system 200(A) can be implemented by a server or database configured to train neural network models. The model-training system 200(A) can be implemented by any additional or alternative computing device or system.

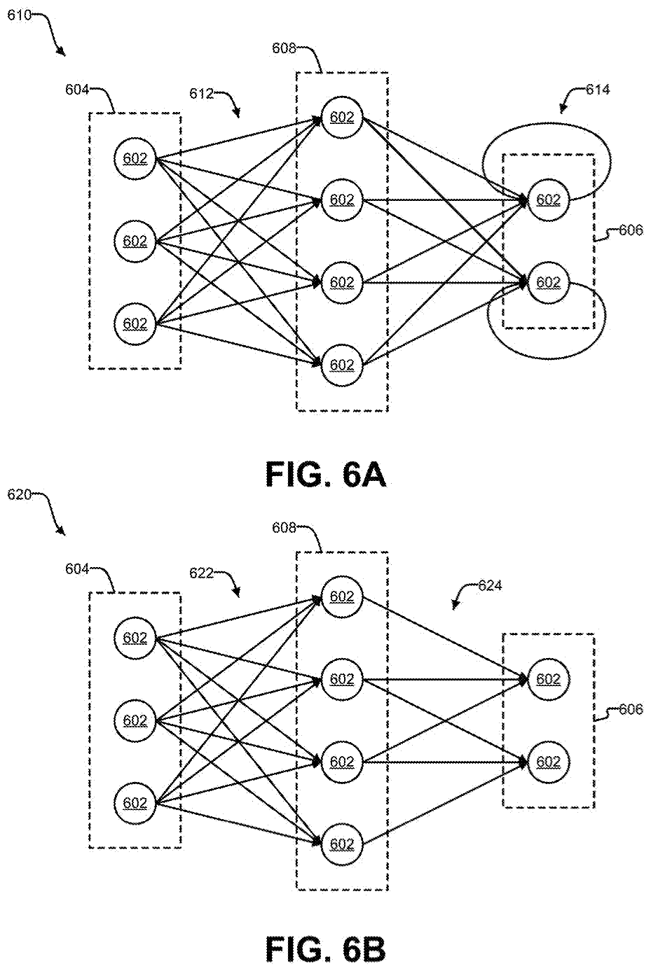

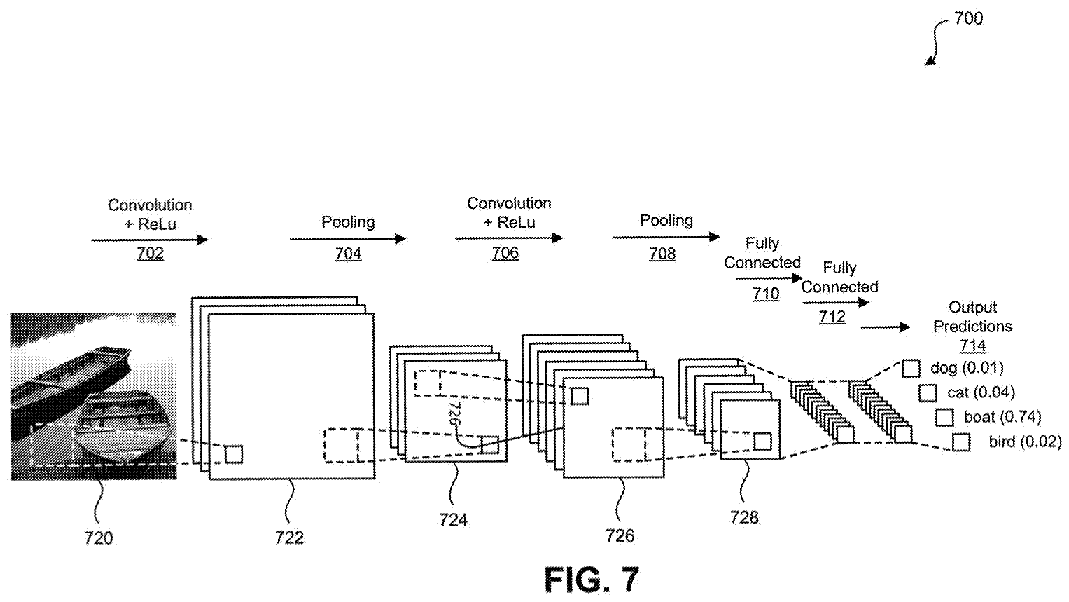

In some cases, the model-training system 200(A) can generate a trained model 210. The trained model 210 can correspond to and/or include various types of machine learning models trained to perform one or more operations. In an illustrative example, the trained model 210 can be trained to perform one or more image processing operations on image data captured by a camera system (e.g., the image sensor 130 of the image capture and processing system 100). The trained model 210 can be trained to perform any other type of operations (e.g., natural language processing operations, recommendation operations, etc.). Further, in one example, the trained model 210 can be a deep neural network, such as a convolutional neural network (CNN). Illustrative examples of deep neural networks are described below with respect to FIG. FIG. 6A, FIG. 6B, and FIG. 7. Additional examples of the trained model 210 include, without limitation, a time delay neural network (TDNN), a deep feed forward neural network (DFFNN), a recurrent neural network (RNN), an auto encoder (AE), a variation AE (VAE), a denoising AE (DAE), a sparse AE (SAE), a markov chain (MC), a perceptron, or some combination thereof.

The trained model 210 can be trained using training data 202, which represents any set or collection of data corresponding to the type and/or format of input data the trained model 210 is to process during inference. For example, if the trained model 210 is being trained to perform an image processing operation on image frames, training data 202 can include a large number (e.g., hundreds, thousands, or millions) of image frames having features, formats, and/or other characteristics relevant to the image processing operation. In an illustrative example, training data 202 can include image frames captured by a mobile device. The image data of these image frames may have a particular data format. For example, a camera system of the mobile device may be configured to output raw image data having an INT8 data type, an INT10 data type, an INT12 data type, an INT16 data type, or any other integer data type. In some cases, it may be beneficial to convert integer-type training data to data having a floating point data type. For example, training the trained model 210 using floating point data can improve the performance and/or accuracy of the trained model 210. Thus, the model-training system 200(A) can include a normalization engine 204 that normalizes integer-type data of training data 202 to floating point data. In an illustrative example, the normalization engine 204 can convert the integer-type data to float32 data with a size range (also referred to as an integer value range) of [0.0-1.0]. The normalization engine 204 can convert the integer-type data to any suitable type of floating point data, and using any suitable type of normalization function. As shown in FIG. 2A, the normalization engine 204 an output normalized training data 206.

In some cases, a training engine 208 of the model-training system 200(A) can use the normalized training data 206 to generate the trained model 210. For example, the training engine 208 can use the normalized training data 206 to iteratively adjust the parameters (e.g., weights, biases, etc.) of one or more layers and/or channels of a deep neural network. Once the deep neural network is sufficiently trained, the training engine 208 can output the trained model 210. For example, the training engine 208 can output a model file indicating the values of the parameters of the trained model 210 (and their corresponding layers and/or channels). The trained model 210 can include any number or combination of convolutional layers, deconvolution layers, scale layers, bias layers, fully-connected layers, and/or other types of layers. Because the training engine 208 uses floating point data to generate the trained model 210, the parameters within the model file are also floating point data.

In some examples, the trained model 210 can be implemented (during inference) using a hardware accelerator. As used herein, a “hardware accelerator” can include a portion of computer hardware designed to perform one or more specific tasks or operations. For instance, a hardware accelerator can include and/or correspond to application-specific hardware. In an illustrative example, the trained model 210 can be implemented by a neural processing unit (NPU) or other microprocessor designed to accelerate the implementation of machine learning algorithms. One example of an NPU that can implement the trained model 210 is a Hexagon Tensor Accelerator (HTA). Additional examples of hardware accelerators that can implement the trained model 210 include, without limitation, a digital signal processor (DSP), a field-programmable array (FPGA), an application-specific integrated circuit (ASIC), a vision processing unit (VPU), a physical neural network (PNN), a tensor processing unit (TPU), a systems-on-chip (SoC), among other hardware accelerators. However, the trained model 210 need not be implemented by a hardware accelerator or other application-specific hardware. For instance, the trained model 210 can be implemented by a central processing unit (CPU) and/or any suitable general-purpose computing architecture.

In one example, the hardware accelerator that implements the trained model 210 can be a fixed-point accelerator. As used herein, a “fixed-point accelerator” can include a hardware accelerator designed to perform calculations using digital data of a particular integer data type. For example, a fixed-point accelerator can be configured and/or optimized to support INT8 data, INT10 data, INT12 data, INT16 data, or another integer data type. In some cases, fixed-point accelerators can provide sufficiently high performance with low latency and/or low power. For example, a fixed-point accelerator (or other hardware accelerator) can be capable of implementing a neural network on a computing device with relatively low processing power (e.g., a mobile device). However, a fixed-point accelerator may be incompatible with floating point data (or integer-type data not of the specific integer data type for which the fixed-point accelerator is configured). Thus, for proper and/or optimal implementation of a machine learning model using a fixed-point accelerator, it may be necessary to quantize the machine learning model and/or the input data. As used herein, “quantization” can refer to the process of converting floating point data to integer-type data.

FIG. 2B is a block diagram of an example model-implementation system 200(B) for quantizing trained machine learning models and/or input data. In some examples, the model-implementation system 200(B) can be implemented by the image capture and processing system 100 illustrated in FIG. 1. For example, the model-implementation system 200(B) can be implemented by the image processor 150 and/or the image sensor 130 of the image capture and processing system 100. The model-implementation system 200(B) can be implemented by any additional or alternative computing device or system.

The model-implementation system 200(B) represents an example of architecture for performing conventional quantization pre-processes. For example, the model-implementation system 200(B) can include a model quantization engine 222 that quantizes the floating point parameters of the trained model 210 (resulting in a fixed integer model 224). The model quantization engine 222 can implement any suitable type of quantization process. In an illustrative example, the quantization process can be performed using the following formulas:

$$q = round ( \frac{f}{delta} ) - offset + {q}_{min} ;$$

$$delta = \frac{{f}_{max} - {f}_{min}}{{q}_{max} - {q}_{min}} ; and$$

$$offset = round ( \frac{{f}_{min}}{delta} ) .$$

In the above formulas, ƒ is the floating point data, q is the quantized data, ƒₘₐₓ and ƒₘᵢₙ are, respectively, the maximum and minimum values that can be represented by the floating point data type of the floating point data, qₘₐₓ max and qₘᵢₙ are, respectively, the maximum and minimum values that can be represented by the integer data type of the quantized data, and round is a rounding function. The rounding function can be a floor function, a ceiling function, a fix function, or any suitable rounding function. In some cases, the fixed integer model 224 can correspond to a version of the trained model 210 configured to process input data having a particular integer data type (e.g., an integer data type associated with a particular hardware accelerator).

In some cases, the model-implementation system 200(B) can receive input data whose data type corresponds to the data type of the fixed integer model 224. For instance, the model-implementation system 200(B) may receive INT10 input data, and the fixed integer model 224 may be configured to process INT10 data. In these cases, the model-implementation system 200(B) can directly provide the input data to the fixed integer model 224 (producing model output 226). However, in many situations, the received input data may be of a different data type. In an illustrative example, the model-implementation system 200 can be implemented on a mobile device that includes a camera system and a fixed-point accelerator. In this example, the camera system may generate image frames having an INT10 data type, and the fixed-point accelerator may be configured to process image frames having an INT16 data type. Inputting INT10 data into the fixed-point accelerator may result in incorrect and/or unusable output. Thus, the model-implementation system 200(B) can include a quantization system 212 that converts input data to the appropriate integer data type. This conversion process can represent a quantization pre-process that prepares input data for inference. As shown, the quantization system 212 can include a normalization engine 228 (e.g., similar to the normalization engine 204 of the model-training system 200(A)). The normalization engine 228 can receive input data 214 (corresponding to a first type of integer-type data). The normalization engine 204 can perform one or more normalization processes on the input data 214, resulting in normalized input data 216 (corresponding to floating point data). A data quantization engine 218 can then quantize the normalized input data 216 to generate quantized input data 220 (corresponding to a second type of integer-type data). The data quantization engine 218 can implement any suitable type of quantization process (such as the quantization process implemented by the model quantization engine 222). The quantization system 212 can input the quantized input data 220 to the fixed integer model 224, generating model output 226.

In some cases, the quantization pre-process corresponding to the quantization system 212 can be implemented on the same computing device that generates the input data 214 and/or implements the fixed integer model 224. For instance, the computing device can be a mobile device that includes a camera system for capturing image frames (e.g., input data 214) and a hardware accelerator for implementing the fixed integer model 224. In this example, the computing device can receive the fixed integer model 224 offline (e.g., a backend server or system configured to generate fixed integer models can export the fixed integer model 224 to the computing device). In some examples, the computing device can be configured to implement the quantization pre-process in response to generating input data (e.g., an image frame) that is to be processed by the fixed integer model 224, which is generated offline and only consumes the configured type of fixed input data. This quantization pre-process can significantly increase the total amount of time involved in processing the image frame using the fixed integer model 224. For instance, a quantization pre-process for high-resolution image data can correspond to approximately 20% of the neural network processing time. In an illustrative example, pre-processing input data of 3000×4000×4 pixels using a CPU can require approximately 400 milliseconds, and inference for the input data using a fixed-point accelerator can require approximately 2 seconds. Thus, quantization pre-processing can introduce undesirable latencies into many image processing operations.

The disclosed systems and techniques can significantly reduce (or even eliminate) quantization pre-processes. For instance, converting data of a first integer data type to a second integer data type can be accomplished by multiplying the data by a scalar value (referred to herein as a “scaling factor”). The scaling factor can correspond to a ratio between a size of the first integer data type and a size of the second integer data type. The size of an integer data type can correspond to the number of distinct integers the integer data type is capable of and/or configured to represent. For instance, the size range of the INT10 data type is 2¹⁰ (e.g., 1024), and the size range of the INT16 data type is 2¹⁶ (e.g., 65536). A value represented by an INT10 data structure can be converted to an INT16 data structure by multiplying the value by a scaling factor of 64

$$( e . g . , \frac{65536}{1024} , or {2}^{6} ) .$$

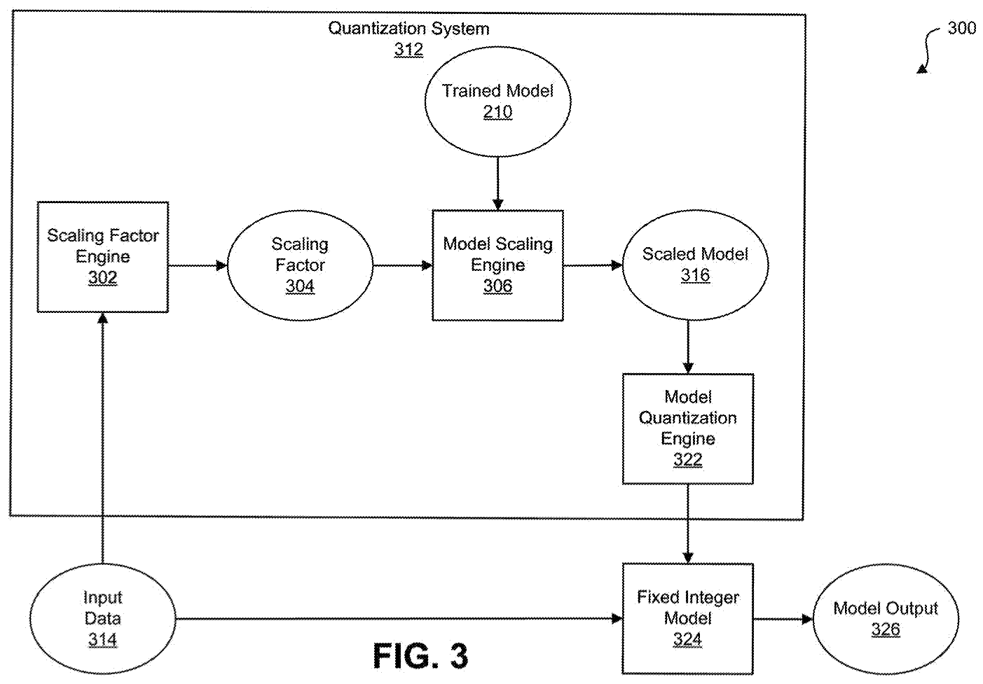

FIG. 3 is a block diagram of an example model-implementation system 300 configured to decrease quantization latencies based on the scaling factor techniques described above. For example, the model-implementation system 300 can include a quantization system 312 that incorporates a scaling factor (e.g., a scaling factor 304) into one or more layers of a neural network (e.g., the trained model 210 shown in FIG. 2A and FIG. 2B). In this example, the quantization system 312 can include a scaling factor engine 302 that determines the scaling factor 304. The scaling factor 304 can correspond to a scaling factor suitable for converting data of a first integer data type to a second integer data type. For example, the scaling factor engine 302 can determine a scaling factor suitable for converting raw image data captured by a particular camera system to an integer data type that can be processed by a particular hardware accelerator. In some cases, the scaling factor engine 302 can determine the scaling factor 304 based on knowledge of the integer data types associated with the camera system and/or the hardware accelerator.

In some examples, a model-scaling engine 306 of the quantization system 312 can scale (e.g., multiply) the parameters of one layer of the trained model 210 based on the scaling factor 304. For instance, the model-scaling engine 306 can multiply each weight, bias, or other parameter of the layer by the scaling factor 304 (e.g., referred to as “broadcasting” the scaling factor 304 to the layer). Further, if the layer includes multiple channels, the model-scaling engine 306 can multiply the parameters of each channel by the scaling factor 304. In some cases, scaling the parameters of the layer by the scaling factor 304 can result in scaling the output of the layer by the scaling factor 304. In this way, scaling the parameters can effectively convert the input data from the first integer data type to the second integer type. In an illustrative example, the model-scaling engine 306 can implement a scaling factor of 64 within one layer of the trained model 210 in order to convert INT10 input data to INT16 input data. In this example, the original output of the layer is given by the equation Y=Σ₀^{k}W Xᵢₙₜ₁₆, where W is the value of a parameter k and Xᵢₙₜ₁₆ is the value of an INT16 input data point. After implementing the scaling factor of 64, the output of the layer can be given by the equation Y=Σ₀^{k}64 Xᵢₙₜ₁₀, where Xᵢₙₜ₁₀ is the value of an INT10 input data point.

The model-scaling engine 306 can scale the parameters of various types of layers of the trained model 210. In an illustrative example, the model-scaling engine 306 can scale the parameters of a convolutional layer. In other examples, the model-scaling engine 306 can scale the parameters of a deconvolution layer, a scale layer, a layer that performs an elementwise operation (e.g., an elementwise bit-shift operation and/or an elementwise multiplication operation), and/or any suitable type of layer. Further, the model-scaling engine 306 can scale the parameters of a layer in any position within the trained model 210. For example, the model-scaling engine 306 can scale the parameters of the first layer, the second layer, the third layer, or any suitable layer. Moreover, in some examples, the model-scaling engine 306 can scale the parameters of multiple layers. For instance, the model-scaling engine 306 can scale the parameters of multiple layers by scaling factors corresponding to divisors of the scaling factor 304. In an illustrative example, if the scaling factor 304 is 32, the model-scaling engine 306 can multiply the parameters of one layer by 2 and the parameters of another layer by 16 (resulting in a total scaling factor of 32).

As shown in FIG. 3, the model-scaling engine 306 can output a scaled model 316, which includes one or more layers whose parameters have been scaled in accordance with the scaling factor 304. As mentioned above, the parameters of the trained model 210 are floating point values. Accordingly, the parameters of the scaled model 316 are also floating point values. To enable the hardware accelerator to implement the scaled model 316, the quantization system 312 can include a model quantization engine 322 that quantizes the scaled model 316 (resulting in a fixed integer model 324). For example, the model quantization engine 322 can quantize each parameter of the scaled model 316. The model quantization engine 322 can use any suitable quantization process (such as the quantization process used by the model quantization engine 222 of the model-implementation system 200(B)). Once the fixed integer model 324 is generated, the model-implementation system 300 can provide input data 314 to the fixed integer model 324, resulting in model output 326.

In some cases, all or a portion of the quantization system 312 can be implemented offline. For example, the quantization system 312 can be implemented by a server or computing device remote from the computing device that implements the fixed integer model 324 during inference. In an illustrative example, the quantization system 312 can generate the fixed integer model 324 on a backend server and then export the fixed integer model 324 to one or more computing devices (e.g., mobile devices). A computing device that receives the fixed integer model 324 can directly provide input data to the fixed integer model 324. For example, as shown in FIG. 3, the input data 314 can be directly passed to the fixed integer model 324 (e.g., without the quantization pre-process illustrated in FIG. 2B). Because the fixed integer model 324 has been adjusted based on the scaling factor 304, the integer data type of the input data 314 does not need to be normalized, quantized, or otherwise adjusted before being processed by the hardware accelerator. Thus, the model-implementation system 300 can eliminate (or almost eliminate) latencies involved in quantization preprocesses.

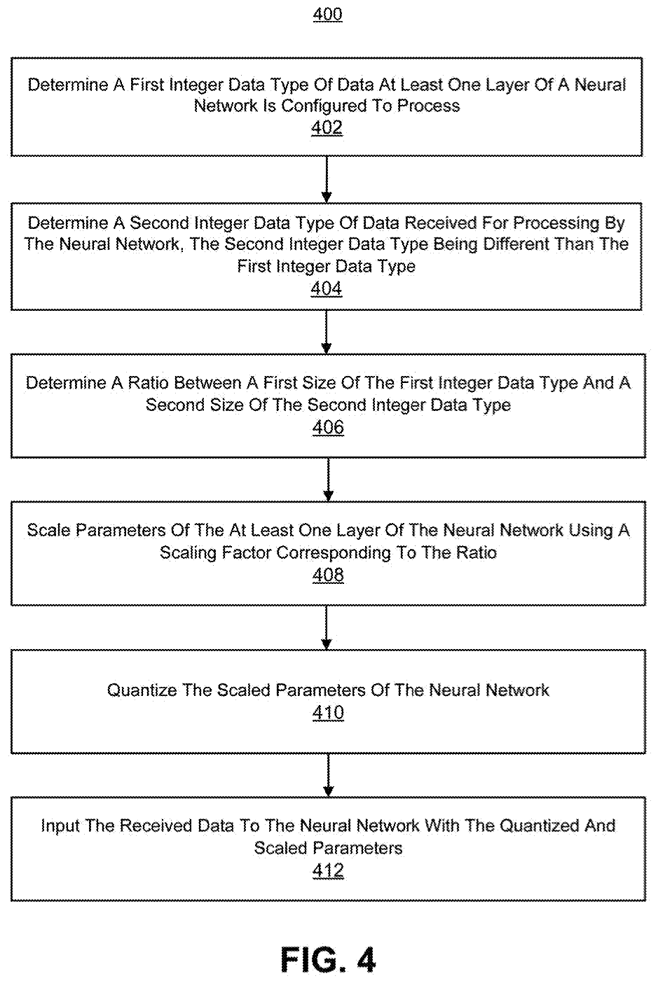

FIG. 4 is a flowchart illustrating an example process 400 for decreasing quantization latency using systems and techniques described herein. At block 402, the process 400 includes determining a first integer data type of data at least one layer of a neural network is configured to process. In some cases, the process 400 can implement the neural network using a hardware accelerator and data of the first integer data type. In some examples, the at least one layer of the neural network corresponds to a single layer of the neural network. In some examples, the at least one layer of the neural network includes a convolutional layer or a deconvolution layer. In some examples, the at least one layer of the neural network includes a scale layer. In some examples, the at least one layer of the neural network includes a layer that performs an elementwise operation.

At block 404, the process 400 includes determining a second integer data type of data received for processing by the neural network. The second integer data type is different than the first integer data type. In some cases, the received data (of the second integer data type) includes image data captured by a camera device. In some aspects, the neural network is trained to perform one or more image processing operations on the image data. In one illustrative example, as described above with respect to FIG. 3, the second integer data type can include raw image data captured by a particular camera system and the first integer data type can be a data type that can be processed by a particular hardware accelerator.

At block 406, the process 400 includes determining a ratio between a first size of the first integer data type and a second size of the second integer data type. In some cases, the first size corresponds to a size range (or an integer value range) of the first integer data type and the second size corresponds to a size range (or an integer value range) of the second integer data type. For instance, the first size of the first integer data type can correspond to a first number of distinct integers the first integer data type is configured to represent, and the second size of the second integer data type can correspond to a second number of distinct integers the second integer data type is configured to represent.

At block 408, the process 400 includes scaling parameters of the at least one layer of the neural network using a scaling factor corresponding to the ratio. For instance, as noted above, the scaling factor (e.g., a scalar value) can correspond to a ratio between the first size of the first integer data type and the second size of the second integer data type. In one illustrative example, the size range of an INT10 data type is 2¹⁰ (e.g., 1024), and the size range of an INT16 data type is 2¹⁶ (e.g., 65536). A value represented by an INT10 data structure can be converted to an INT16 data structure by multiplying the value by a scaling factor of 64 (e.g., 65536/1024, or 2⁶). In some examples, the ratio and the scaling factor can be determined by the scaling factor engine 302 of FIG. 3.

At block 410, the process 400 includes quantizing the scaled parameters of the neural network. In some examples, the scaled parameters can be quantized by the model quantization engine 322 of FIG. 3. For instance, the model quantization engine 322 can quantize the scaled model 316, resulting in a fixed integer model 324. Any suitable quantization process can be used.

At block 412, the process 400 includes inputting the received data to the neural network with the quantized and scaled parameters. For instance, once the fixed integer model 324 is generated, the model-implementation system 300 can provide input data 314 to the fixed integer model 324, resulting in model output 326. In some cases, the process 400 includes inputting the received data to the neural network without quantizing the received data. In some cases, the process 400 includes quantizing parameters of one or more additional layers of the neural network.

In some cases, the process 400 includes training the neural network using training data of a floating point data type. In some examples, training the neural network generates neural network parameters of the floating point data type. In some aspects, the process 400 includes converting the neural network parameters from the floating point data type to the first integer data type.

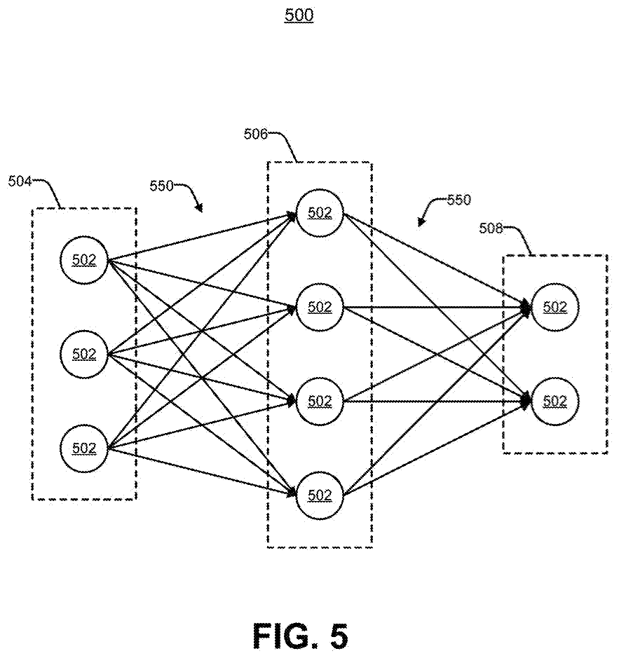

FIG. 5 is a diagram illustrating an example of a visual model 500 for a neural network. In some cases, the model 500 can correspond to an example architecture of the trained model 210 in FIG. 2A, FIG. 2B, and FIG. 3. In this example, the model 500 includes an input layer 504, a middle layer that is often referred to as a hidden layer 506, and an output layer 508. Each layer includes some number of nodes 502. In this example, each node 502 of the input layer 504 is connected to each node 502 of the hidden layer 506. The connections, which would be referred to as synapses in the brain model, are referred to as weights 550. The input layer 504 can receive inputs and can propagate the inputs to the hidden layer 506. Also in this example, each node 502 of the hidden layer 506 has a connection or weight 550 with each node 502 of the output layer 508. In some cases, a neural network implementation can include multiple hidden layers. Weighted sums computed by the hidden layer 506 (or multiple hidden layers) are propagated to the output layer 508, which can present final outputs for different uses (e.g., providing a classification result, detecting an object, tracking an object, and/or other suitable uses). The outputs of the different nodes 502 (weighted sums) can be referred to as activations (also referred to as activation data), in keeping with the brain model.

An example of a computation that can occur at each layer in the example visual model 500 is as follows:

$${y}_{j} = f ( {\sum }_{i = 1}^{3} {W}_{ij} \times {x}_{i} + b )$$

In the above equation, Wij is a weight, xi is an input activation, yj is an output activation, f( ) is a non-linear function, and b is a bias term. Using an input image as an example, each connection between a node and a receptive field for that node can learn a weight Wij and, in some cases, an overall bias b such that each node learns to analyze its particular local receptive field in the input image. Each node of a hidden layer can have the same weights and bias (called a shared weight and a shared bias). Various non-linear functions can be used to achieve different purposes.

The model 500 can be referred to as a directed, weighted graph. In a directed graph, each connection to or from a node indicates a direction (e.g., into the node or away from the node). In a weighted graph, each connection can have a weight. Tools for developing neural networks can visualize the neural network as a directed, weighted graph, for ease of understanding and debuggability. In some cases, these tools can also be used to train the neural network and output trained weight values. Executing the neural network is then a matter of using the weights to conduct computations on input data.

A neural network that has more than three layers (e.g., more than one hidden layer) is sometimes referred to as a deep neural network. Deep neural networks can have, for example, five to more than a thousand layers. Neural networks with many layers can be capable of learning high-level tasks that have more complexity and abstraction than shallower networks. As an example, a deep neural network can be taught to recognize objects or scenes in images. In this example, pixels of an image can be fed into the input layer of the deep neural network, and the outputs of the first layer can indicate the presences of low-level features in the image, such as lines and edges. At subsequent layers, these features can be combined to measure the likely presence of higher level features: the lines can be combined into shapes, which can be further combined into sets of shapes. Given such information, the deep neural network can output a probability that the high-level features represent a particular object or scene. For example, the deep neural network can output whether an image contains a cat or does not contain a cat.

The learning phase of a neural network is referred to as training the neural network. During training, the neural network is taught to perform a task. In learning the task, values for the weights (and possibly also the bias) are determined. The underlying program for the neural network (e.g., the organization of nodes into layers, the connections between the nodes of each layer, and the computation executed by each node), does not need to change during training. Once trained, the neural network can perform the task by computing a result using the weight values (and bias values, in some cases) that were determined during training. For example, the neural network can output the probability that an image contains a particular object, the probability that an audio sequence contains a particular word, a bounding box in an image around an object, or a proposed action that should be taken. Running the program for the neural network is referred to as inference.

There are multiple ways in which weights can be trained. One method is called supervised learning. In supervised learning, all training samples are labeled, so that inputting each training sample into a neural network produces a known result. Another method is called unsupervised learning, where the training samples are not labeled. In unsupervised learning, training aims to find a structure in the data or clusters in the data. Semi-supervised learning falls between supervised and unsupervised learning. In semi-supervised learning, a subset of training data is labeled. The unlabeled data can be used to define cluster boundaries and the labeled data can be used to label the clusters.

Different varieties of neural networks have been developed. Various examples of neural networks can be divided into two forms: feed-forward and recurrent. FIG. 6A is a diagram illustrating an example of a model 610 for a neural network that includes feed-forward weights 612 between an input layer 604 and a hidden layer 606, and recurrent weights 614 at the output layer 608. In a feed-forward neural network, the computation is a sequence of operations on the outputs of a previous layer, with the final layer generating the outputs of the neural network. In the example illustrated in FIG. 6A, feed-forward is illustrated by the hidden layer 606, whose nodes 602 operate only on the outputs of the nodes 602 in the input layer 604. A feed-forward neural network has no memory and the output for a given input can be always the same, irrespective of any previous inputs given to the neural network. The Multi-Layer Perceptron (MLP) is one type of neural network that has only feed-forward weights.

In contrast, recurrent neural networks have an internal memory that can allow dependencies to affect the output. In a recurrent neural network, some intermediate operations can generate values that are stored internally and that can be used as inputs to other operations, in conjunction with the processing of later input data. In the example of FIG. 6A, recurrence is illustrated by the output layer 608, where the outputs of the nodes 602 of the output layer 608 are connected back to the inputs of the nodes 602 of the output layer 608. These looped-back connections can be referred to as recurrent weights 614. Long Short-Term Memory (LSTM) is a frequently used recurrent neural network variant.

FIG. 6B is a diagram illustrating an example of a model 620 for a neural network that includes different connection types. In this example model 620, the input layer 604 and the hidden layer 606 are fully connected 622 layers. In a fully connected layer, all output activations are composed of the weighted input activations (e.g., the outputs of all the nodes 602 in the input layer 604 are connected to the inputs of all the nodes 602 of the hidden layer 606). Fully connected layers can require a significant amount of storage and computations. Multi-Layer Perceptron neural networks are one type of neural network that is fully connected.

In some applications, some connections between the activations can be removed, for example by setting the weights for these connections to zero, without affecting the accuracy of the output. The result is sparsely connected 624 layers, illustrated in FIG. 6B by the weights between the hidden layer 606 and the output layer 608. Pooling is another example of a method that can achieve sparsely connected 624 layers. In pooling, the outputs of a cluster of nodes can be combined, for example by finding a maximum value, minimum value, mean value, or median value.

A category of neural networks referred to as convolutional neural networks (CNNs) have been particularly effective for image recognition and classification (e.g., facial expression recognition and/or classification). A convolutional neural network can learn, for example, categories of images, and can output a statistical likelihood that an input image falls within one of the categories.

FIG. 7 is a diagram illustrating an example of a model 700 for a convolutional neural network. The model 700 illustrates operations that can be included in a convolutional neural network: convolution, activation, pooling (also referred to as sub-sampling), batch normalization, and output generation (e.g., a fully connected layer). As an example, the convolutional neural network illustrated by the model 700 is a classification network providing output predictions 714 of different classes of objects (e.g., dog, cat, boat, bird). Any given convolutional network includes at least one convolutional layer, and can have many convolutional layers. Additionally, each convolutional layer need not be followed by a pooling layer. In some examples, a pooling layer may occur after multiple convolutional layers, or may not occur at all. The example convolutional network illustrated in FIG. 7 classifies an input image 720 into one of four categories: dog, cat, boat, or bird. In the illustrated example, on receiving an image of a boat as input, the example neural network outputs the highest probability for “boat” (0.94) among the output predictions 714.

To produce the illustrated output predictions 714, the example convolutional neural network performs a first convolution with a rectified linear unit (ReLU) 702, pooling 704, a second convolution with ReLU 706, additional pooling 708, and then categorization using two fully-connected layers 710, 712. In the first convolution with ReLU 702 operation, the input image 720 is convolved to produce one or more output feature maps 722 (including activation data). The first pooling 704 operation produces additional feature maps 724, which function as input feature maps for the second convolution and ReLU 706 operation. The second convolution with ReLU 706 operation produces a second set of output feature maps 726 with activation data. The additional pooling 708 step also produces feature maps 728, which are input into a first fully-connected layer 710. The output of the first fully-connected layer 710 is input into a second fully-connect layer 712. The outputs of the second fully-connected layer 712 are the output predictions 714. In convolutional neural networks, the terms “higher layer” and “higher-level layer” refer to layers further away from the input image (e.g., in the example model 700, the second fully-connected 712 layer is the highest layer).

The example of FIG. 7 is one example of a convolutional neural network. Other examples can include additional or fewer convolution operations, ReLU operations, pooling operations, and/or fully-connected layers. Convolution, non-linearity (ReLU), pooling or sub-sampling, and categorization operations will be explained in greater detail below.

When conducting an image processing function (e.g., image recognition, object detection, object classification, object tracking, or other suitable function), a convolutional neural network can operate on a numerical or digital representation of the image. An image can be represented in a computer as a matrix of pixel values. For example, a video frame captured at 1080p includes an array of pixels that is 1920 pixels across and 1080 pixels high. Certain components of an image can be referred to as a channel. For example, a color image has three color channels: red (R), green (G), and blue (B) or luma (Y), chroma red (Cr), and chroma blue (Cb). In this example, a color image can be represented as three two-dimensional matrices, one for each color, with the horizontal and vertical axis indicating a location of a pixel in the image and a value between 0 and 255 indicating a color intensity for the pixel. As another example, a greyscale image has only one channel, and thus can be represented as a single two-dimensional matrix of pixel values. In this example, the pixel values can also be between 0 and 255, with 0 indicating black and 255 indicating white, for example. The upper value of 255, in these examples, assumes that the pixels are represented by 8-bit values. In other examples, the pixels can be represented using more bits (e.g., 16, 32, or more bits), and thus can have higher upper values.

As shown in FIG. 7, a convolutional network is a sequence of layers. Every layer of a convolutional neural network transforms one volume of activation data (also referred to as activations) to another volume of activation through a differentiable function. For example, each layer can accepts an input 3D volume and can transforms that input 3D volume to an output 3D volume through a differentiable function. Three types of layers that can be used to build convolutional neural network architectures can include convolutional layers, pooling layers, and one or more fully-connected layer. A network also includes an input layer, which can hold raw pixel values of an image. For example, an example image can have a width of 32 pixels, a height of 32 pixels, and three color channels (e.g., R, G, and B color channels). Each node of the convolutional layer is connected to a region of nodes (pixels) of the input image. The region is called a receptive field. In some cases, a convolutional layer can compute the output of nodes (also referred to as neurons) that are connected to local regions in the input, each node computing a dot product between its weights and a small region they are connected to in the input volume. Such a computation can result in volume [32×32×12] if 12 filters are used. The ReLu layer can apply an elementwise activation function, such as the max(0,x) thresholding at zero, which leaves the size of the volume unchanged at [32×32×12]. The pooling layer can perform a downsampling operation along the spatial dimensions (width, height), resulting in reduced volume of data, such as a volume of data with a size of [16×16×12]. The fully-connected layer can compute the class scores, resulting in volume of size [1×1×4], where each of the four (4) numbers correspond to a class score, such as among the four categories of dog, cat, boat, and bird. The CIFAR-10 network is an example of such a network, and has ten categories of objects. Using such a neural network, an original image can be transformed layer by layer from the original pixel values to the final class scores. Some layers contain parameters and others may not. For example, the convolutional and fully-connected layers perform transformations that are a function of the activations in the input volume and also of the parameters (the weights and biases) of the nodes, while the ReLu and pooling layers can implement a fixed function.

A convolution is a mathematical operation that can be used to extract features from an input image. Features that can be extracted include, for example, edges, curves, corners, blobs, and ridges, among others. Convolution preserves the spatial relationship between pixels by learning image features using small squares of input data.

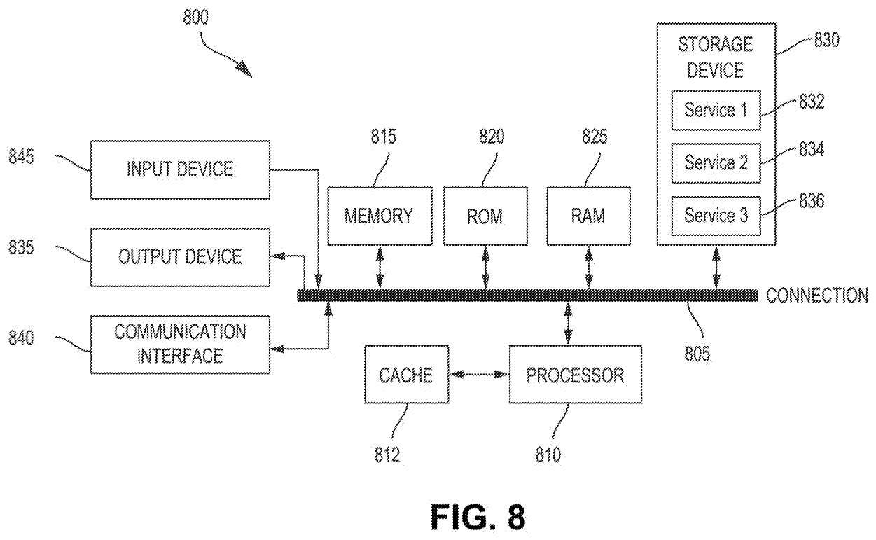

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for decreasing quantization latency, the apparatus comprising: a memory; one or more processors coupled to the memory and configured to: determine a first integer data type of data at least one layer of a neural network is configured to process; determine a second integer data type of data received for processing by the neural network, the second integer data type being different than the first integer data type; determine a ratio between a first size of the first integer data type and a second size of the second integer data type; scale parameters of the at least one layer of the neural network using a scaling factor corresponding to the ratio; quantize the scaled parameters of the neural network; and input the received data to the neural network with the quantized and scaled parameters.
Aspect 2. The apparatus of aspect 1, further comprising a hardware accelerator configured to implement the neural network using data of the first integer data type.
Aspect 3. The apparatus of any of aspects 1 or 2, wherein: the received data includes image data captured by a camera device of the apparatus; and the neural network is trained to perform one or more image processing operations on the image data.
Aspect 4. The apparatus of any of aspects 1 to 3, wherein the one or more processors are configured to train the neural network using training data of a floating point data type, wherein training the neural network generates neural network parameters of the floating point data type.
Aspect 5. The apparatus of aspect 4, wherein the one or more processors are configured to convert the neural network parameters from the floating point data type to the first integer data type.
Aspect 6. The apparatus of any of aspects 1 to 5, wherein: the at least one layer of the neural network corresponds to a single layer of the neural network; and the scaling factor is the ratio between the first size of the first integer data type and the second size of the second integer data type.
Aspect 7. The apparatus of any of aspects 1 to 6, wherein: the first size of the first integer data type corresponds to a first number of distinct integers the first integer data type is configured to represent; and the second size of the second integer data type corresponds to a second number of distinct integers the second integer data type is configured to represent.
Aspect 8. The apparatus of any of aspects 1 to 7, wherein the at least one layer of the neural network includes a convolutional layer or a deconvolution layer.
Aspect 9. The apparatus of any of aspects 1 to 7, wherein the at least one layer of the neural network includes a scale layer.
Aspect 10. The apparatus of any of aspects 1 to 7, wherein the at least one layer of the neural network includes a layer that performs an elementwise operation.
Aspect 11. The apparatus of aspects 1 to 10, wherein the one or more processors are configured to input the received data to the neural network without quantizing the received data.
Aspect 12. The apparatus of any of aspects 1 to 11, wherein the one or more processors are configured to quantize parameters of one or more additional layers of the neural network.
Aspect 13. The apparatus of any of aspects 1 to 12, wherein the apparatus includes a mobile device.
Aspect 14. The apparatus of any of aspects 1 to 13, further comprising a display.
Aspect 15. A method of decreasing quantization latency, the method comprising: determining a first integer data type of data at least one layer of a neural network is configured to process; determining a second integer data type of data received for processing by the neural network, the second integer data type being different than the first integer data type; determining a ratio between a first size of the first integer data type and a second size of the second integer data type; scaling parameters of the at least one layer of the neural network using a scaling factor corresponding to the ratio; quantizing the scaled parameters of the neural network; and inputting the received data to the neural network with the quantized and scaled parameters.
Aspect 16. The apparatus of aspect 15, further comprising implementing the neural network using a hardware accelerator and data of the first integer data type.
Aspect 17. The method of any of aspects 15 or 16, wherein: the received data includes image data captured by a camera device; and the neural network is trained to perform one or more image processing operations on the image data.
Aspect 18. The method of any of aspects 15 to 17, further comprising training the neural network using training data of a floating point data type, wherein training the neural network generates neural network parameters of the floating point data type.
Aspect 19. The method of aspect 19, further comprising converting the neural network parameters from the floating point data type to the first integer data type.
Aspect 20. The method of any of aspects 15 to 19, wherein: the at least one layer of the neural network corresponds to a single layer of the neural network; and the scaling factor is the ratio between the first size of the first integer data type and the second size of the second integer data type.
Aspect 21. The method of any of aspects 15 to 20, wherein: the first size of the first integer data type corresponds to a first number of distinct integers the first integer data type is configured to represent; and the second size of the second integer data type corresponds to a second number of distinct integers the second integer data type is configured to represent.
Aspect 22. The method of any of aspects 15 to 21, wherein the at least one layer of the neural network includes a convolutional layer or a deconvolution layer.
Aspect 23. The method of any of aspects 15 to 21, wherein the at least one layer of the neural network includes a scale layer.
Aspect 24. The method of any of aspects 15 to 21, wherein the at least one layer of the neural network includes a layer that performs an elementwise operation.
Aspect 25. The method of aspects 15 to 24, further comprising inputting the received data to the neural network without quantizing the received data.
Aspect 26. The method of any of aspects 15 to 25, further comprising quantizing parameters of one or more additional layers of the neural network.
Aspect 27. A computer-readable storage medium storing instructions that, when executed by one or more processors, cause the one or more processors to perform any of the operations of Aspects 1 to 26.
Aspect 28. An apparatus comprising means for performing any of the operations of Aspects 1 to 26.

1. An apparatus for decreasing quantization latency, the apparatus comprising:
a memory;
one or more processors coupled to the memory and configured to:
determine a first integer data type of data at least one layer of a neural network is configured to process;
determine a second integer data type of data received for processing by the neural network, the second integer data type being different than the first integer data type;
determine a ratio between a first size of the first integer data type and a second size of the second integer data type;
scale parameters of the at least one layer of the neural network using a scaling factor corresponding to the ratio;
quantize the scaled parameters of the neural network; and
input the received data to the neural network with the quantized and scaled parameters.

2. The apparatus of claim 1, further comprising a hardware accelerator configured to implement the neural network using data of the first integer data type.

3. The apparatus of any one of claim 1, wherein:
the received data includes image data captured by a camera device of the apparatus; and
the neural network is trained to perform one or more image processing operations on the image data.

4. The apparatus of claim 1, wherein the one or more processors are configured to train the neural network using training data of a floating point data type, wherein training the neural network generates neural network parameters of the floating point data type.

5. The apparatus of claim 4, wherein the one or more processors are configured to convert the neural network parameters from the floating point data type to the first integer data type.

6. The apparatus of claim 1, wherein:
the at least one layer of the neural network corresponds to a single layer of the neural network; and
the scaling factor is the ratio between the first size of the first integer data type and the second size of the second integer data type.

7. The apparatus of claim 1, wherein:
the first size of the first integer data type corresponds to a first number of distinct integers the first integer data type is configured to represent; and
the second size of the second integer data type corresponds to a second number of distinct integers the second integer data type is configured to represent.

8. The apparatus of claim 1, wherein the at least one layer of the neural network includes a convolutional layer or a deconvolution layer.

9. The apparatus of claim 1, wherein the at least one layer of the neural network includes a scale layer.

10. The apparatus of claim 1, wherein the at least one layer of the neural network includes a layer that performs an elementwise operation.

11. The apparatus of claim 1, wherein the one or more processors are configured to input the received data to the neural network without quantizing the received data.

12. The apparatus of claim 1, wherein the one or more processors are configured to quantize parameters of one or more additional layers of the neural network.

13. The apparatus of claim 1, wherein the apparatus includes a mobile device.

14. The apparatus of claim 1, further comprising a display.

15. A method of decreasing quantization latency, the method comprising:
determining a first integer data type of data at least one layer of a neural network is configured to process;
determining a second integer data type of data received for processing by the neural network, the second integer data type being different than the first integer data type;
determining a ratio between a first size of the first integer data type and a second size of the second integer data type;
scaling parameters of the at least one layer of the neural network using a scaling factor corresponding to the ratio;
quantizing the scaled parameters of the neural network; and
inputting the received data to the neural network with the quantized and scaled parameters.

16. The method of claim 15, further comprising implementing the neural network using a hardware accelerator and data of the first integer data type.

17. The method of claim 15, wherein:
the received data includes image data captured by a camera device; and
the neural network is trained to perform one or more image processing operations on the image data.

18. The method of claim 15, further comprising training the neural network using training data of a floating point data type, wherein training the neural network generates neural network parameters of the floating point data type.

19. The method of claim 18, further comprising converting the neural network parameters from the floating point data type to the first integer data type.

20. The method of claim 15, wherein:
the at least one layer of the neural network corresponds to a single layer of the neural network; and
the scaling factor is the ratio between the first size of the first integer data type and the second size of the second integer data type.

21. The method of claim 15, wherein:
the first size of the first integer data type corresponds to a first number of distinct integers the first integer data type is configured to represent; and
the second size of the second integer data type corresponds to a second number of distinct integers the second integer data type is configured to represent.

22. The method of claim 15, wherein the at least one layer of the neural network includes a convolutional layer or a deconvolution layer.

23. The method of claim 15, wherein the at least one layer of the neural network includes a scale layer.

24. The method of claim 15, wherein the at least one layer of the neural network includes a layer that performs an elementwise operation.

25. The method of claim 15, further comprising inputting the received data to the neural network without quantizing the received data.

26. The method of claim 15, further comprising quantizing parameters of one or more additional layers of the neural network.

27. A non-transitory computer-readable medium having stored thereon instructions that, when executed by one or more processors, cause the one or more processors to:
determine a first integer data type of data at least one layer of a neural network is configured to process;
determine a second integer data type of data received for processing by the neural network, the second integer data type being different than the first integer data type;
determine a ratio between a first size of the first integer data type and a second size of the second integer data type;
scale parameters of the at least one layer of the neural network using a scaling factor corresponding to the ratio;
quantize the scaled parameters of the neural network; and
input the received data to the neural network with the quantized and scaled parameters.

28. The non-transitory computer-readable medium of claim 27, further comprising instructions that, when executed by one or more processors, cause the one or more processors to implement the neural network using a hardware accelerator and data of the first integer data type.

29. The non-transitory computer-readable medium of claim 27, wherein:
the received data includes image data captured by a camera device; and
the neural network is trained to perform one or more image processing operations on the image data.

30. The non-transitory computer-readable medium of claim 27, further comprising instructions that, when executed by one or more processors, cause the one or more processors to train the neural network using training data of a floating point data type, wherein training the neural network generates neural network parameters of the floating point data type.
